(19) United States
(12) Patent Application Publication
(10) Pub. No.: US 2005/0242212 A1
(43) Pub. Date: Nov. 3, 2005

(54) Injector with fuel deposit-resistant director plate

(76) Inventors: Thomas J. Chapaton, Sterling Heights, MI (US); Chester N. Grant, Ortonville, MI (US)

Correspondence Address: KARL F. BARR JR.;General Motors Corporation, Legal Staff, Mail Code 482-C23-B21, P.O. Box 300, Detroit, MI, 48265-3000, US

(21) Appl. No.: 10/836,659

(22) Filed: Apr. 30, 2004

(51) Int. Cl. F02M 61/00

(52) U.S. Cl. 239/533.12

(57) ABSTRACT

An engine fuel injector for spraying fuel into an air intake passage includes an injection nozzle having a fuel passage with a valve seat selectively engagable by an electromagnetically-actuated valve member to control fuel delivery through the nozzle. A director plate outwardly adjacent the valve seat includes: an inner side, adapted for exposure to liquid fuel in the nozzle; a plurality of spray openings through the plate, adapted for directing fuel spray into such air intake passage for mixing and vaporization with air charges in the passage; and an outer side, adapted for exposure to mixtures of engine intake air and fuel spray in the intake passage. The director plate has at least a portion formed of a conductive fuel deposit-resistant fluoropolymer material. The plate may be formed of the fluoropolymer or the material may be coated onto a supporting substrate.

### TECHNICAL FIELD

This invention relates to fuel injectors for injecting atomized fuel spray into engine intake ports or manifold runners, and particularly to multiple orifice fuel spray director plates for such injectors, the plates having surfaces resistant to the formation of spray altering fuel deposits.

### BACKGROUND OF THE INVENTION

It is known in the art to provide automotive fuels with deposit controlling additives to avoid the formation of fuel deposits that might interfere with proper operation of fuel injectors or alter their desired spray patterns for atomizing fuel delivered to engine intake passages, such as manifold runners or cylinder intake ports. However, high temperatures reached during operation or after engine shutdown may result in fuel fractionation and deposition of high molecular weight material in the fuel as deposits on multiple orifice director plates. Further means for limiting such deposits have been desired to maintain fuel spray consistency.

For high pressure injectors delivering fuel through a single nozzle orifice directly into an engine combustion chamber, it has been proposed to limit deposits on the nozzle valve seat of combustion products formed in the chamber by altering the orifice configuration and by applying a coating to the needle valve seat. A carbon-based coating has been mentioned with alternatives of aluminum-based, ceramic and fluoropolymer-based materials. The conditions for direct injection of fuel to the combustion chamber differ from those for fuel injection into air intake passages. In the intake passages, pressures and temperatures are lower, combustion chamber deposits are not involved and multi-hole director plates may be used to direct the fuel spray.

### SUMMARY OF THE INVENTION

The present invention provides a fuel injector for injecting fuel into an engine air intake passage, such as a manifold runner or an intake port. The injector is provided with a fuel deposit-resistant director plate formed as a generally planar sheet or thin plate having a plurality of spray openings for directing fuel spray into an air intake passage leading to a valve controlled cylinder intake port. The sheet has an inner side, adapted for exposure to vaporizable liquid fuel delivered to the director plate for injection, and an outer side, adapted for exposure to engine intake air and fuel spray mixing in the intake passage. The director plate includes at least a portion formed of a fuel deposit-resistant fluoropolymer material.

Numerous alternative embodiments include forming the entire director plate of the fluoropolymer material or coating a preformed substrate with a fluoropolymer coating. Various selected portions of the plate may be coated, preferably portions in or adjacent to the spray openings.

The family of fluoropolymers appears to be particularly suited for protecting a director plate against deposits of high molecular weight fuel components which would tend to coat the plate surface and form spray diverting or blocking deposits. PTFE (Teflon) material is an example of fluoropolymers considered suitable for this application. Other fluoropolymer materials which have adequate temperature and chemical resistance for use in engine fuel system applications could be used instead of PTFE. All the materials should be formulated to be conductive to avoid static charge buildup.

These and other features and advantages of the invention will be more fully understood from the following description of certain specific embodiments of the invention taken together with the accompanying drawings.

### BRIEF DESCRIPTION OF THE DRAWINGS

FIG. 1 is a nozzle end view of an electromagnetic fuel injector showing the fuel director plate partially coated with residual fuel deposits;

FIG. 2 is a cross-sectional view of the lower portion of a needle valve type fuel injector similar to that shown in FIG. 1;

FIG. 3 is a cross-sectional view of the director plate of the injector FIG. 2;

FIG. 4 is a cross-sectional view of the nozzle portion of an alternative injector embodiment having a flexible injection valve engaging a combination valve seat and director plate;

FIG. 5 is a plan view showing the form of the valve seat and director plate for the injector in FIG. 4;

FIG. 6 is an enlarged cross-sectional view showing a coated central portion of a director plate similar to the plate of FIGS. 2 and 3; and

FIG. 7 is a view similar to FIG. 6 showing the coated central portion of a director plate similar to the seat/director of FIGS. 4 and 5.

### DESCRIPTION OF THE PREFERRED EMBODIMENT

Referring now to the drawings in detail, numeral 10 generally indicates a needle valve-type fuel injector having a nozzle end 12 carrying a retainer sleeve 14 having a central opening in which is mounted a fuel director plate 16 having four spray directing orifices or spray openings 18 grouped near the center of the plate 16. The nozzle end 12 of the injector 10 is adapted to be received in an opening of an engine intake manifold or cylinder head connecting with an intake air passage, such as an intake runner or intake port, leading to a valve controlled engine cylinder, not shown.

During operation of the injector, high molecular weight fuel residuals and other substances in the fuel may form deposits 20, on inner or outer surfaces of the director plate 16 and sleeve 14. In time, these deposits may grow and interfere with the pattern of fuel spray through the spray holes 18 so as to adversely affect mixing of the air and fuel in the air intake passages.

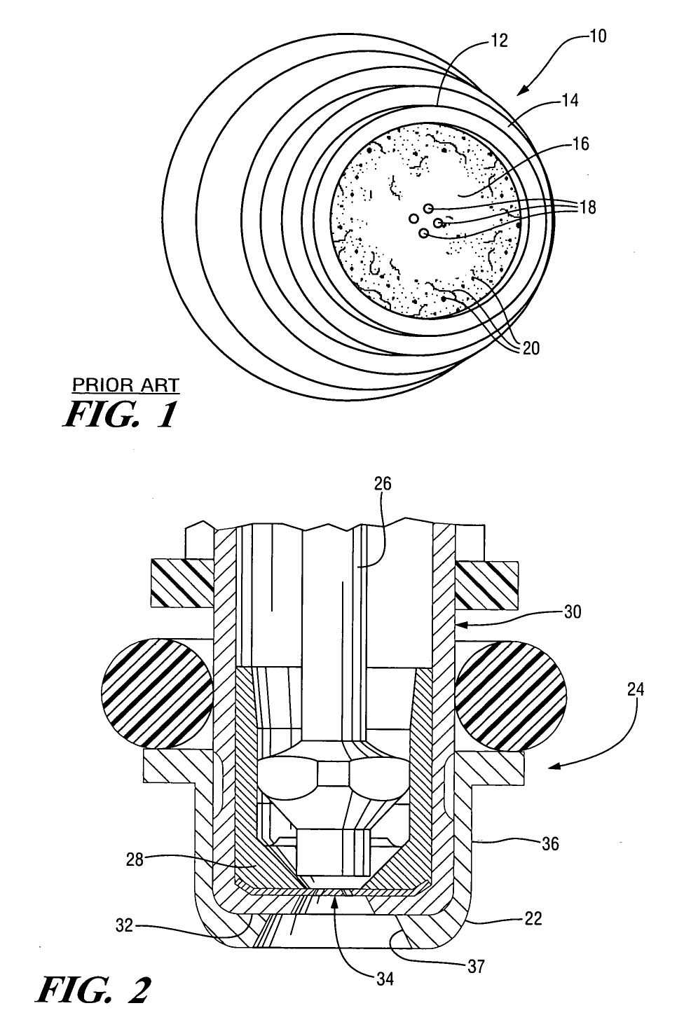

FIG. 2 of the drawings shows the nozzle end 22 of a fuel injector 24 of a type similar to that of injector 10, shown FIG. 1. Injector 24 includes an electro-magnetically actuated needle valve 26 guided by a valve seat 28 retained within a fuel tube 30. An outer end flange 32 on the fuel tube retains a director plate 34 between the flange 32 and the valve seat 28. A seal retainer 36 is fitted over the end of the fuel tube 30 and includes a central opening 37 communicating through the fuel tube with the director plate 34.

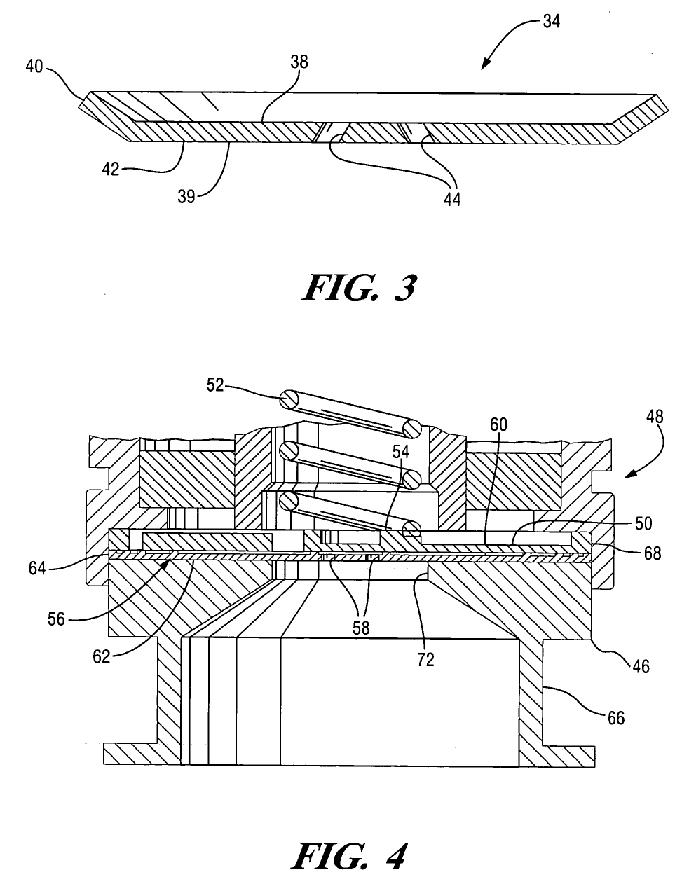

FIG. 3 shows in cross-section the form of the director plate 34 which includes an inner side 38, an outer side 39, and an upturned rim 40 surrounding generally flat central portion 42. A plurality of spray openings 44 extend through the plate central portion, 42.

FIG. 4 illustrates the nozzle end 46 of a disk valve-type fuel injector 48. Injector 48 includes a magnetically-actuated disk armature and fuel injection valve 50, which is biased by a spring 52 against a valve seat ring 54 of a combination seat/director plate 56.

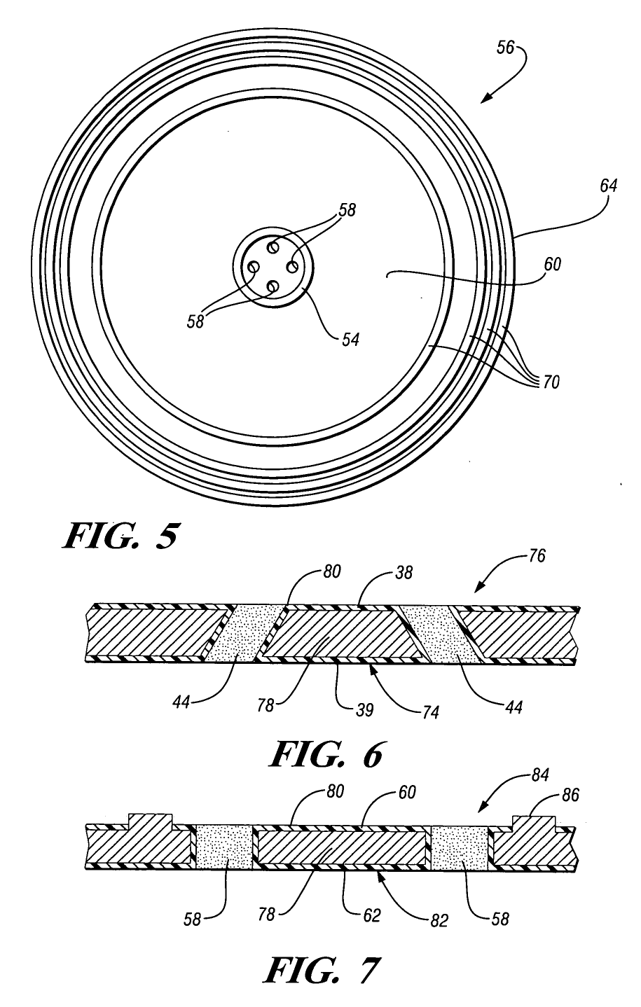

FIG. 5 shows a top view of the plate 56, which includes four spray openings 58 spaced within the valve seat ring 54. The director plate 56 has an inner side 60 exposed to liquid fuel within the injector. An outer side 62 is exposed in operation to fuel spray and air-fuel mixture created within an associated intake air passage formed by an intake manifold runner or cylinder intake port, not shown. The seat/director plate 56 is generally planar, the outer side 62 being essentially flat. An outer edge 64 is clamped between an outlet nozzle member 66 and a spacer 68, forming a stationary part of the injection valve 50.

In operation of injectors 24 and 48, after engine shutdown, fuel deposits can form on the inner and outer surfaces of the respective director plates 34, 56 and possibly on the inner peripheries of their orifices or spray openings 44, 46. Sources of the fuel deposits may include fractionation of the fuel as it evaporates. After shutdown of the engine, a small amount of fuel may be retained on the plate surfaces. When exposed to elevated temperatures and/or atmospheric pressure, it will slowly evaporate, distilling off the lighter compounds until only the high molecular weight material remains. This material will coat the exposed surfaces of the director plate and orifices without any chemical reactions being required. Polynuclear aromatics (PNAs) would form this type of deposit.

Components in the fuel may also react chemically with oxygen to form polar compounds. These polar compounds may be surface active and have an affinity for metal director plate spray openings or surfaces. They may have limited solubility in the fuel and precipitate out of solution, coating the surfaces of the plate plus the spray opening surfaces. Sulfur and nitrogen compounds also react with oxygen to form insoluble material that could also contribute to this type of deposit.

To prevent or resist formation of such fuel deposits on the sides and spray openings of the director plates 34, 56 of injectors 24, 48, the director plates may be made from or coated with deposit resisting conductive fluoropolymer materials such as polytetrafluoroethylene (PTFE), also known as Teflon. Other fluoropolymer materials which have adequate temperature and chemical resistance for use in engine fuel system applications could be used instead of PTFE. All the materials should be formulated to be conductive to avoid static charge buildup.

For example, the director plate 34 of injector 24 may be formed from a solid sheet of PTFE or other suitable fluoropolymer material. Alternatively, the sheet may be formed of a suitable substrate and coated with the PTFE or other deposit resisting material.

In the case of injector 48, shown in FIG. 4, the seat director 56 would not be suitable for manufacture as a solid sheet of PTFE, since the valve seat ring 54 must be made of a much harder material. Accordingly, the seat director plate 56 may be coated with PTFE or another suitable material in the portions surrounding the spray openings 58. The inner peripheries of the spray openings may also be coated. Preferably the surface of the upper side 60 will be coated except for the raised valve seating 54 and the surrounding annular ribs 70. If desired, the coating could be applied over the complete outer side 62, or it could be restricted to the portion of the outer side surface which is exposed to the associated intake air passage through the outlet nozzle member 66 and its central opening 72.

As an example, FIG. 6 shows, enlarged, the central portion 74 of a director plate 76, similar to plate 34 of FIGS. 2 and 3. Director plate 76 is formed of a steel body or substrate 78 having the exposed surfaces 38, 39, 44 of the central portion 74 coated with a deposit resistant fluoropolymer material 80 such as PTFE.

FIG. 7 similarly shows, enlarged, the central portion 82 of a director plate 84 similar to seat/director 56 of FIGS. 4 and 5. Again, the exposed surfaces 58, 60, 62 of the central portion 82, except for the raised valve seat ring 86, are coated with a deposit-resistant material 80 such as PTFE. These coatings 80 are shown applied to portions of the director plates in and surrounding the spray openings 44, 58. However, it should be understood that the coatings could be applied over any portions of the director plate surfaces where the formation of fuel deposits could be detrimental to injector operation.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A fuel director plate adapted for use in an engine intake passage injector nozzle, said director plate being generally planar and having a plurality of spray openings adapted for directing injected fuel spray through the openings into an air intake passage leading to a valve controlled cylinder intake port, the plate having an inner side adapted for exposure to at least partially vaporizable liquid fuel delivered to the director plate for injection, and an outer side adapted for exposure to engine intake air and fuel spray mixing in the intake passage, and the improvement comprising:
said director plate having at least a portion formed of a fluoropolymer material substantially equal to PTFE in resistance to the formation of residual fuel deposits thereon.

2. A director plate as in claim 1 wherein the director plate is formed of the fluoropolymer material.

3. A director plate as in claim 1 wherein the director plate is formed of a supporting base material having a coating of the fluoropolymer material.

4. A director plate as in claim 3 wherein the coating is disposed adjacent the spray openings.

5. A director plate as in claim 3 wherein the coating is in the spray openings.

6. A director plate as in claim 3 wherein the coating is on at least the outer side of the plate.

7. A director plate as in claim 1 wherein said fluoropolymer material is PTFE.

8. A director plate as in claim 1 wherein a central portion of the plate is essentially flat.

9. A director plate as in claim 1 wherein a central portion of the plate has a curvature.

10. A director plate as in claim 1 wherein the generally planar plate has a non-planar outer edge adapted to be held by a surrounding retainer.

11. A fuel injector adapted for injection of vaporizable liquid fuel into a cylinder air intake passage of a spark ignition engine, the injector including an injection nozzle having a fuel passage with a valve seat selectively engagable by an electromagnetically actuated valve member to control delivery of pressurized fuel through the nozzle, and a director plate outwardly adjacent the valve seat, the director plate including an inner side adapted for exposure to liquid fuel in the nozzle, a plurality of spray openings through the plate adapted for directing injected fuel spray through the openings into such air intake passage for mixing and vaporization with air charges in the passage, and an outer side adapted for exposure to mixtures of engine intake air and fuel spray in the intake passage and the improvement wherein:
the director plate has at least a portion formed of a fluoropolymer material substantially equal to PTFE in resistance to the formation of residual fuel deposits thereon.

12. A fuel injector as in claim 11 wherein peripheral inner surfaces of the director plate spray openings are formed of said fluoropolymer material.

13. A fuel injector as in claim 11 wherein the outer side of the director plate adjacent the spray openings is formed of said fluoropolymer material.

14. A fuel injector as in claim 11 wherein the inner side of the director plate adjacent the spray openings is formed of said fluoropolymer material.

15. A fuel injector as in claim 12 wherein the director plate adjacent the spray openings is also formed of said fluoropolymer material.
